(19) United States
(12) Patent Application Publication
(10) Pub. No.: US 2008/0256215 A1
(43) Pub. Date: Oct. 16, 2008

(54) Method for Tourist Guiding and Showing Information of Tourist Spots Using Mobile Device

(75) Inventor: Wei Chang, Hsinchu (TW)

Correspondence Address: WPAT, PC, 7225 BEVERLY ST., ANNANDALE, VA, 22003, US

(73) Assignee: MSTAR SEMICONDUCTOR,INC, Hsinchu (TW)

(21) Appl. No.: 11/952,398

(22) Filed: Dec. 7, 2007

(30) Foreign Application Priority Data
Apr. 11, 2007 (TW) 096112650

(51) Int. Cl. G06F 15/16; G01S 5/00

(52) U.S. Cl. 709/217; 701/213

(57) ABSTRACT

The present invention provides a method for tourist guiding and showing information of tourist spots using a mobile device. The method comprises: an information center picking up information of a tourist spot from a database according to a request of a user and transmitting the information to a car electronic device, wherein the information comprises identification data of an identification device installed in the tourist spot; the user downloading the information from the car electronic device by the mobile device; and the mobile device displaying the information of the tourist spot according to the identification data after the user uses the mobile device to read the identification device.

### BACKGROUND OF THE INVENTION

1. Field of the Invention

The present invention generally relates to an interactive tourist guiding method and, more particularly, to a tourist guiding method using a mobile device to showing the information of tourist spots.

2. Description of the Prior Art

In a modern society, the mobile phone has become indispensable since it reduces time for communicating messages. The mobile phone is portable and can be linked to the car so that the driver can use it with the speaker and the microphone inside the car to speak over the telephone voice service.

Moreover, with the increasing popularity of car electronic devices such as global positioning systems (GPSs) and electronic maps, the car electronic devices can be integrated with liquid crystal display (LCD) monitors and DVD/VCD players to build up an integrated car host computer/electronic device. Also, a larger amount of data can be stored because the car electronic devices have a relatively larger memory space than the mobile phone.

Furthermore, the modern people emphasize the importance of leisure. With the convenience brought forth by the automobiles, the visitors crowd into the tourist spots on holidays. However, information of a desired tourist spot is always insufficient due to limited time for preparation. As a result, the visitors can only have a slightest idea of the tourist spot by looking at the bulletin boards set up in the tourist spot, which reduces the interest in visiting.

Therefore, there is a need in providing a tourist guiding method using a mobile device for real-time showing the information of the tourist spot to increase of the visitors, which brings forth greater chance for business.

### SUMMARY OF THE INVENTION

It is one object of the present invention to provide a tourist guiding method using a mobile device to download information of a tourist spot and an identification device installed in the tourist spot for real-time showing the information of the tourist spot.

To achieve the above object, the first aspect of the present invention provides a method for tourist guiding and showing information of tourist spots using a mobile device. The method comprises: an information center picking up information of a tourist spot from a database according to a request of a user and transmitting the information to a car electronic device, wherein the information comprises identification data of an identification device installed in the tourist spot; the user downloading the information from the car electronic device by the mobile device; and the mobile device displaying the information of the tourist spot according to the identification data after the user uses the mobile device to read the identification device.

It is preferably that the method further comprises a step of: the user updating the information of the tourist spot.

It is preferably that the identification device is a radio-frequency identification (RFID) tag or a barcode.

To achieve the above object, the second aspect of the present invention provides a method for tourist guiding and showing information of tourist spots using a mobile device. The method comprises steps of: installing an identification device on each of a plurality of objects for identification; storing description information of each of the plurality of objects into an information center; downloading the description information from the information center using a mobile device; and displaying the description information corresponding to one of the plurality of objects on the mobile device after the mobile device reads the identification device on the one of the plurality of objects.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a schematic diagram of a tourist guiding system using a mobile device according to the present invention;

FIG. 2 is a flow-chart showing a tourist guiding method using a mobile device according to one embodiment the present invention; and

FIG. 3 is a flow-chart showing a tourist guiding method using a mobile device according to another embodiment of the present invention.

### DETAILED DESCRIPTION OF THE PREFERRED EMBODIMENT

The present invention discloses a method for tourist guiding and showing information of tourist spots using a mobile device and can be exemplified by the preferred embodiments as described hereinafter.

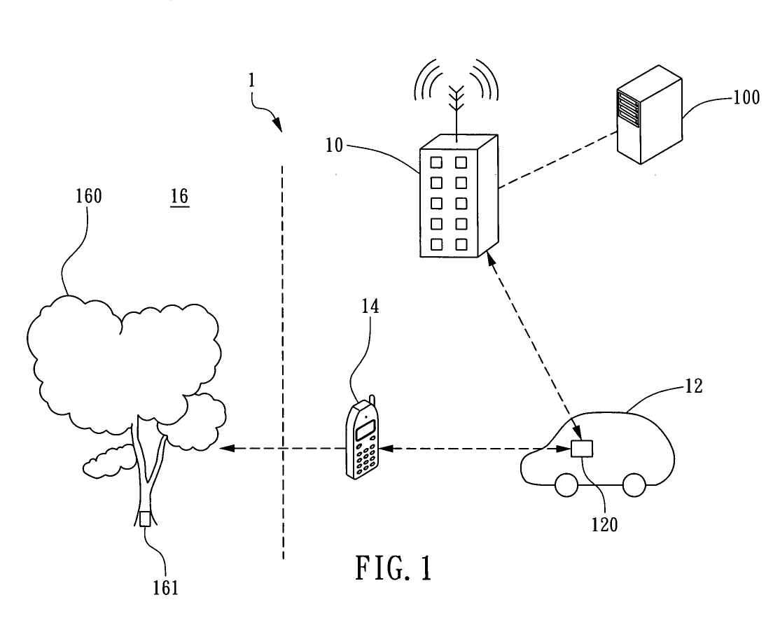

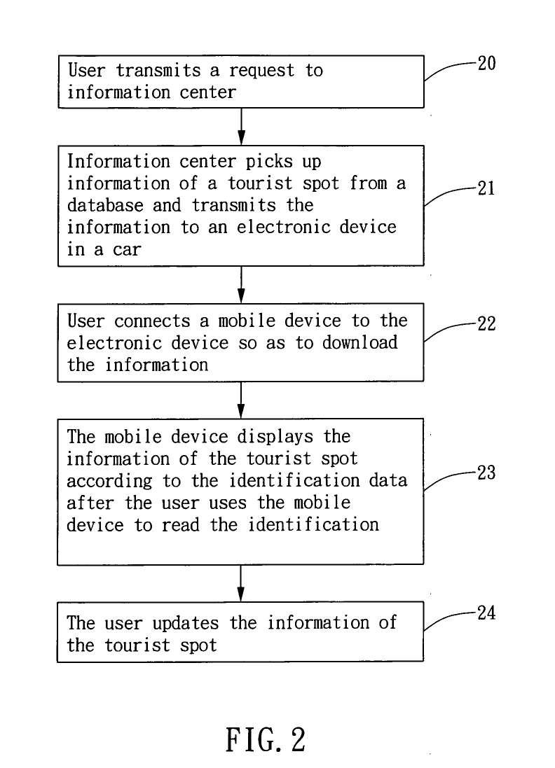

Please refer to FIG. 1 and FIG. 2, wherein FIG. 1 is a schematic diagram of a tourist guiding system using a mobile device according to the present invention and, FIG. 2 is a flow-chart showing a tourist guiding method using a mobile device according to one embodiment the present invention.

In FIG. 1, the tourist guiding system 1 of the present invention comprises an information center 10, a car 12 and a mobile phone 14 of a user. The information center 10 is linked to a database 100 storing information of a plurality of tourist spots. The information of a tourist spot comprises description information of objects disposed in the tourist spot. The description information of each one of the objects comprises an identification data of an identification device (such as radio-frequency identification (RFID) tag) installed on the corresponding object. For example, the database 100 stores information such as the breed, age, features and photos of a tree 160, when the object is the tree 160 in the tourist spot 16. The car 12 has a car electronic device 120 installed therein. The car electronic device 120 comprises a car computer, and/or a GPS.

The steps of the tourist guiding method are described in Step 20 to Step 24 in FIG. 2.

In Step 20, a user (not shown in FIG. 1) transmits a request related to a tourist spot 16 to an information center 10 when he/she wants to go to the tourist spot 16. The request comprises information of the tourist spot 16 such as the name and/or address of the tourist spot 16. The user can use the car electronic device 120 to transmit the request when he/she is in the car 12.

Then, the information center 10 picks up the information of the tourist spot 16 from the database 100 and transmits the information to the car electronic device 120 in the car 12 after the information center 10 receives the request, as described in Step 21. The information of tourist spot 16 comprises the description information of each object disposed in tourist spot 16. The information center 10 communicates with the car electronic device 120 using general packet radio service (GPRS) or third generation (3G) communication.

In Step 22, the user uses the mobile device 14 to connect to the car electronic device 120 so as to download and store the information of tourist spot 16. The mobile device 14 communicates with the car electronic device 120 using Bluetooth, near-field communication (NFC) or infrared ray communication. Alternatively, the user can also use the mobile device 14 to connect to the car electronic device 120 by a conventional transmission line.

Then, in Step 23, the user uses the mobile device 14 to read the identification device 161 installed on the tree 160 when he/she visits the tourist spot 16. The identification device 161 can be an RFID tag or a barcode. After the mobile device 14 reads the identification device 161, the description information of the tree 160 can be found according to the identification data of the identification device 161. Then, the mobile device 14 displays the description information of the tree 160 such as the breed, age, features and photos of the tree 16 for the user to read.

Furthermore, the user can update or add texts and/or photos to the description information displayed on the mobile device 14 so as to provide a new filed to be stored, as described in Step 24.

Certainly, in the method of the present invention, the request is not limited to be transmitted when the user is in the car 12. The user can transmit the request to the information center 10 using a browser through the Internet before he/she starts off. Alternatively, the user can transmit the request to the information center 10 through a telephone voice service or a mobile communication service using the mobile device 14.

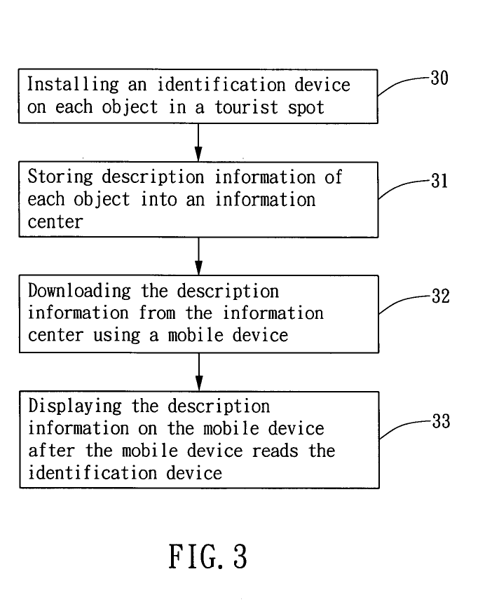

Please also refer to FIG. 3, which is a flow-chart showing a tourist guiding method using a mobile device according to another embodiment of the present invention. For example, visiting on a museum is described.

To begin with, in Step 30, an identification device is installed on each object in a tourist spot for identification. For example, an identification device is installed on each object displayed in a museum. The identification device can be an RFID tag or a barcode.

In Step 31, description information of each object is stored into an information center. For example, description information of each object displayed in a museum is stored into an information center. The description information of each object comprises the identification information of the identification device installed on the corresponding object. Please note that Step 30 and Step 31 are in no particular order.

In Step 32, the description information is downloaded from the information center using a mobile device. For example, a downloading location can be provided at the entrance of the museum. At the downloading location, the user can use a mobile device or a PDA to connect to the information center over a wireless communication service to download the description information from the information center. The wireless communication service can be Bluetooth, near-field communication (NFC) or infrared ray communication.

In Step 33, the description information of an object is displayed on the mobile device after the mobile device reads the identification device on the object. For example, when the user is interested in one displaying object, he/she can use the mobile device to read the identification device installed on the displaying object. Then the mobile device identifies the object according to the downloaded description information and displays the description information corresponding to the interested object on the monitor.

Certainly, the afore-mentioned communication tools are only described as examples. Usage of any other communication tool with the method of the present invention is within the scope thereof.

Accordingly, the present invention discloses a tourist guiding method that overcomes the problems in the conventional bulletin boards so that real-time showing the information of tourist spots is achieved on demand.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A method for tourist guiding and showing information of tourist spots using a mobile device, the method comprising:
an information center picking up information of a tourist spot from a database according to a request of a user and transmitting the information to a car electronic device, wherein the information comprises identification data of an identification device installed in the tourist spot;
the user downloading the information from the car electronic device by the mobile device; and
the mobile device displaying the information of the tourist spot according to the identification data after the user uses the mobile device to read the identification device.

2. The method as recited in claim 1, further comprising a step of:
the user updating the information of the tourist spot.

3. The method as recited in claim 1, wherein the user transmits the request from the car electronic device.

4. The method as recited in claim 3, wherein the car electronic device comprises a global positioning system (GPS).

5. The method as recited in claim 1, wherein the request comprises the address or the name of the tourist spot.

6. The method as recited in claim 1, wherein the identification device is a radio-frequency identification (RFID) tag.

7. The method as recited in claim 1, wherein the identification device is a barcode.

8. The method as recited in claim 1, wherein the user transmits the request to the information center through the Internet.

9. The method as recited in claim 1, wherein the user transmits the request to the information center through a telephone voice service.

10. The method as recited in claim 1, wherein the user transmits the request to the information center through a mobile communication service using the mobile device.

11. The method as recited in claim 1, wherein the mobile device is a mobile phone or a personal digital assistant (PDA).

12. The method as recited in claim 1, wherein the mobile device communicates with the car electronic device using Bluetooth, near-field communication (NFC) or infrared ray communication.

13. The method as recited in claim 1, wherein the mobile device communicates with the car electronic device using a transmission line.

14. The method as recited in claim 1, wherein the car electronic device communicates with the information center using general packet radio service (GPRS) or third generation (3G) communication.

15. A method for tourist guiding and showing information of tourist spots using a mobile device, the method comprising steps of:
installing an identification device on each of a plurality of objects for identification;
storing description information of each of the plurality of objects into an information center;
downloading the description information from the information center using a mobile device; and
displaying the description information corresponding to one of the plurality of objects on the mobile device after the mobile device reads the identification device on the one of the plurality of objects.

16. The method as recited in claim 15, wherein the plurality of objects are disposed in a tourist spot.

17. The method as recited in claim 15, wherein the mobile device downloads the description information corresponding to the plurality of objects from the information center using a wireless communication service.

18. The method as recited in claim 17, wherein the wireless communication service is Bluetooth, near-field communication (NFC) or infrared ray communication.

19. The method as recited in claim 15, wherein the identification device is a radio-frequency identification (RFID) tag.

20. The method as recited in claim 15, wherein the mobile device is a mobile phone or a personal digital assistant (PDA).
